(19) United States
(12) Patent Application Publication
(10) Pub. No.: US 2025/0028027 A1
(43) Pub. Date: Jan. 23, 2025

(54) RANGING DEVICE

(71) Applicant: DENSO CORPORATION, Kariya-city (JP)

(72) Inventor: Kohei TOYAMA, Kariya-city (JP)

(21) Appl. No.: 18/907,302

(22) Filed: Oct. 4, 2024

Related U.S. Application Data
(63) Continuation of application No. PCT/JP2023/011851, filed on Mar. 24, 2023.

(30) Foreign Application Priority Data
Apr. 8, 2022 (JP) 2022-064529

(51) Int. Cl. G01S 7/481; G01S 17/08

(52) U.S. Cl. CPC G01S 7/4813; G01S 17/08

(57) ABSTRACT

A ranging device includes a transmitting section, a receiving section, a housing, a transmissive section, and a heating section. The transmitting section transmits a transmission wave. The receiving section receives a reflection wave caused by reflection of the transmission wave from an object. The housing encloses the transmitting section and the receiving section and has an opening formed for allowing the transmission wave and the reflection wave to pass therethrough. The transmissive section is formed of a material transparent to the transmission wave and the reflection wave, and covers the opening. The heating section includes a mesh of metal having a plurality of mesh openings and is disposed to cover at least a portion of the opening. The heating section generates heat by energising the metal to heat the transmissive section.

### CROSS-REFERENCE TO RELATED APPLICATION

This application is a continuation application of International Application No. PCT/JP2023/011851 filed Mar. 24, 2023 which designated the U.S. and claims priority to Japanese Patent Application No. 2022-064529 filed with the Japan Patent Office on Apr. 8, 2022, the contents of each of which are incorporated herein by reference.

### BACKGROUND

### Technical Field

The present disclosure relates to a ranging device for measuring a distance to an object.

### Related Art

A ranging device is known that measures a distance to an object by transmitting transmission waves and receiving reflection waves caused by reflection of the transmission waves from the object, in which an electric heating conductor is provided outside a transmission window through which the transmission waves pass, that is, in and around a reception window through which the reflection waves pass.

### BRIEF DESCRIPTION OF THE DRAWINGS

In the accompanying drawings:

FIG. 1 is a perspective view of a ranging device according to each of the first to fifth embodiments;

FIG. 2 is an exploded perspective view of the ranging device according to each of the first to fifth embodiments;

FIG. 3 is a perspective view of a detection module;

FIG. 4 is a plan view of a metal mesh heater according to the first embodiment;

FIG. 5 is an illustration of the intensity distribution of a transmission wave;

FIG. 6 is a plan view of a metal mesh heater according to the second embodiment;

FIG. 7 is a plan view of a metal mesh heater according to the third embodiment;

FIG. 8 is a plan view of a metal mesh heater according to the fourth embodiment;

FIG. 9 is a side view of a metal mesh heater and an optical window according to the fifth embodiment;

FIG. 10 is a cross-sectional view illustrating a schematic configuration of the ranging device according to a sixth embodiment;

FIG. 11 is a cross-sectional view illustrating a schematic configuration of the ranging device according to a seventh embodiment;

FIG. 12 is a plan view of a metal mesh heater according to another embodiment.

### DESCRIPTION OF SPECIFIC EMBODIMENTS

After a careful review of WO2013/092168 disclosing the above known ranging device, the present inventors have found the following issue. According to the technology disclosed in WO2013/092168, the electric heating conductor is provided outside the transmission window, and snow and water droplets adhering to the ranging device may fail to be sufficiently removed, which prevents the transmission waves from passing through the transmission window, thus leading to a reduction in the ranging performance of the ranging device.

In view of the foregoing, it is desired to have a technology for improving the ranging performance of the ranging device.

One aspect of the present disclosure provides a ranging device including a transmitting section, a receiving section, a housing, a transmissive section, and a heating section.

The transmitting section is configured to transmit a transmission wave.

The receiving section is configured to receive a reflection wave caused by reflection of the transmission wave from an object.

The housing encloses the transmitting section and the receiving section and has an opening formed for allowing the transmission wave and the reflection wave to pass therethrough.

The transmissive section is formed of a material transparent to the transmission wave and the reflection wave, and covers the opening.

The heating section includes a mesh of metal having a plurality of mesh openings and is disposed to cover at least a portion of the opening. The heating section generates heat by energising the metal to heat the transmissive section.

In such a ranging device configured as above, the heating section is disposed so as to cover at least a portion of the opening. Therefore, the ranging device of the present disclosure can improve the capability of heating the transmissive section using the heating section. This can prevent occurrence of a situation where transmission and reflection waves fail to pass through the transmissive section due to insufficient removal of snow and water droplets adhering to the ranging device.

Furthermore, in the ranging device of the present disclosure, the heating section has a plurality of mesh openings, which are formed in a mesh using metal. Therefore, even in a configuration where the heating section is disposed so as to cover a portion of the opening, this can prevent the transmission and reflection waves from being blocked by the heating section.

With the above configuration, the ranging device of this disclosure can improve the ranging performance of the ranging device.

### First Embodiment

A first embodiment of the present disclosure will now be described with reference to accompanying drawings.

A ranging device 1 of the present embodiment is mounted to a vehicle and is used to measure distances and directions to various objects that are present around the vehicle.

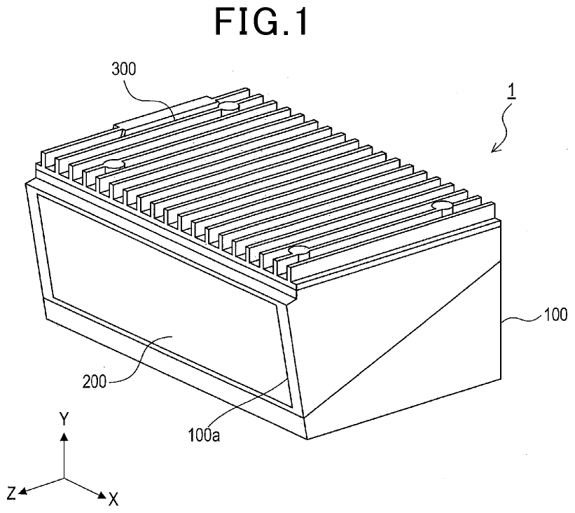

As illustrated in FIG. 1, the ranging device 1 includes a housing 100, an optical window 200, and a heat sink 300.

The housing 100 is a cuboid-shaped box made of resin or metal, which includes an opening 100a in one of the six faces.

The optical window 200 is a lid made of resin or glass, which is fixed to the housing 100 so as to cover the opening 100a of the housing 100. The laser light transmitted from a detection module 2 disposed inside the housing 100 passes through the interior of the optical window 200.

Hereinafter, the direction along the longitudinal direction of the opening 100a, which is formed as a substantially rectangular shape, is defined as the X-axis direction, the direction along the lateral direction of the opening 100a is defined as the Y-axis direction, and the direction that is orthogonal to the X-axis and Y-axis directions is defined as the Z-axis direction. The left-right direction in the X-axis direction and the up-down direction in the Y-axis direction are defined as viewed from the side of the opening 100a of the housing 100. In addition, the front and back in the Z-axis direction are defined as the front side being the side of the opening 100a of the housing 100 and the back side being the opposite side.

The heat sink 300 is disposed on the outer surface of the housing 100 in order to dissipate heat generated inside the housing 100. In the present embodiment, the heat sink 300 is disposed on the top surface of the housing 100.

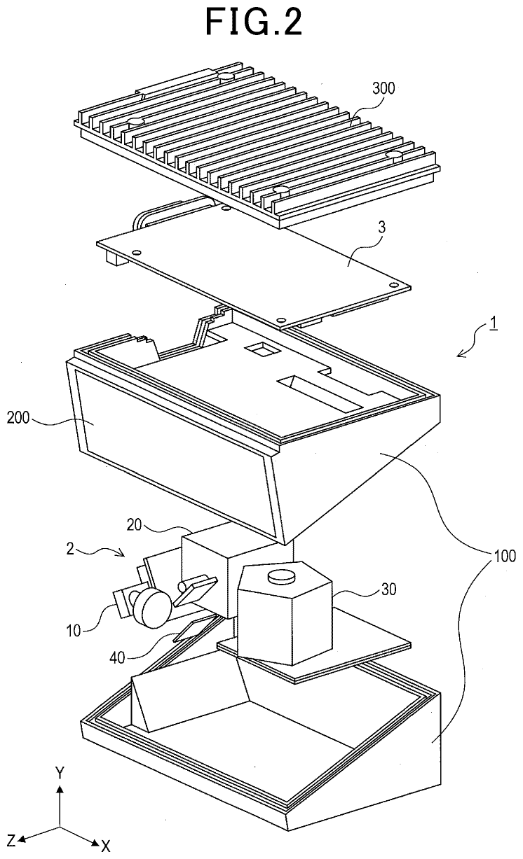

As illustrated in FIG. 2, the ranging device 1 further includes a detection module 2 and a control board 3 that controls the detection module 2. The detection module 2 and the control board 3 are housed within the housing 10

The detection module 2 includes a transceiver unit 10, an oscillating scanner 20, a polygon scanner 30, and a folding mirror 40.

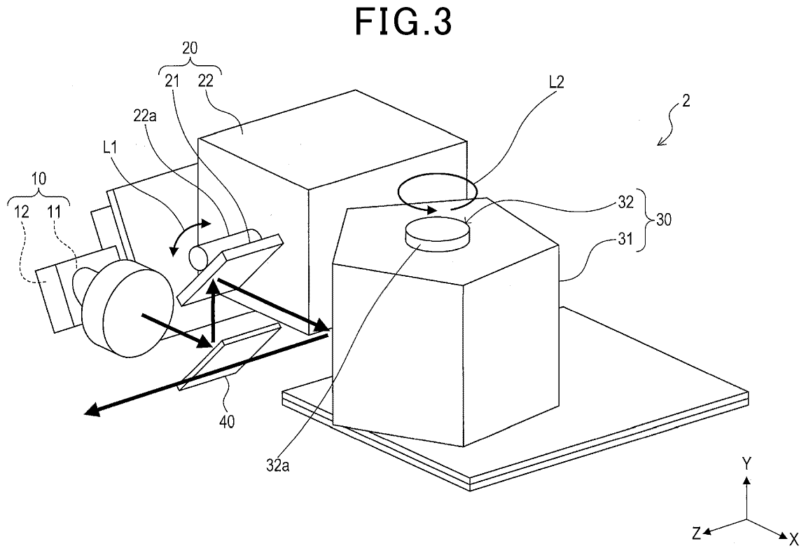

As illustrated in FIG. 3, the transceiver unit 10 includes a transmitting section 11 and a receiving section 12. The transmitting section 11 and receiving section 12 are housed within the transceiver unit 10.

The transmitting section 11 generates laser light and transmits the generated laser light as a transmission wave. In the present embodiment, the wavelength of the transmission wave is 1550 nm.

The receiving section 12 receives, as a reception wave, the reflection wave caused by reflection of the transmission wave from an object.

The oscillating scanner 20 includes an oscillating mirror 21 and an oscillating motor 22.

The oscillating mirror 21 is a flat plate-shaped member with a reflective surface that reflects laser light. The oscillating motor 22 includes an output shaft 22a for outputting a rotational driving force. The oscillating mirror 21 is connected to the output shaft 22a such that its reflective surface rotates around the output shaft 22a, as indicated by the arrow L1. In the present embodiment, the output shaft 22a is parallel to the Z-axis direction.

The polygon scanner 30 includes a polygon mirror 31 and a rotary motor 32.

The polygon mirror 31 is a rotating polygon mirror with a plurality of reflective surfaces that reflect laser light.

The rotary motor 32 includes an output shaft 32a for outputting a rotational driving force. The polygon mirror 31 is connected to the output shaft 32a such that its reflective surfaces rotate around the output shaft 32a, as indicated by the arrow L2. In the present embodiment, the output shaft 32a is parallel to the Y-axis direction.

The folding mirror 40 is a flat-shaped member with a reflective surface that reflects laser light. The folding mirror 40 is installed so as to reflect the transmission wave transmitted from the transmitting section 11 and arriving at the folding mirror 40 towards the oscillating mirror 21, and to reflect the reflection wave arriving at the folding mirror 40 after being reflected by the oscillating mirror 21 towards the receiving section 12.

Therefore, the ranging device 1 performs a horizontal scan with the transmission wave transmitted from the transmitting section 11 along the X-axis direction by rotating the polygon mirror 31. Furthermore, the ranging device 1 performs a vertical scan with the transmission wave transmitted from the transmitting section 11 along the Y-axis direction by oscillating the oscillating mirror 21.

The ranging device 1 reflects the reflected light entering the housing 100 through the optical window 200 from outside the housing 100 via the polygon mirror 31, the oscillating mirror 21 and the folding mirror 40 in this order, and receives the reflected light at the receiving section 12.

A control section (not shown) is mounted on the control board 3. The control section controls the timing at which the transmitting section 11 transmits the transmission wave in synchronization with rotation of the oscillating mirror 21 and the polygon mirror 31.

The control section then measures a distance to an object that reflected the transmission wave based on a difference between the time when the transmission wave was transmitted by the transmitting section 11 and the time when the receiving section 12 received the reflection wave. The control unit also measures an azimuth angle of the object that reflected the transmission wave based on scanning angles of the oscillating mirror 21 and the polygon mirror 31 at the time the transmission wave was transmitted.

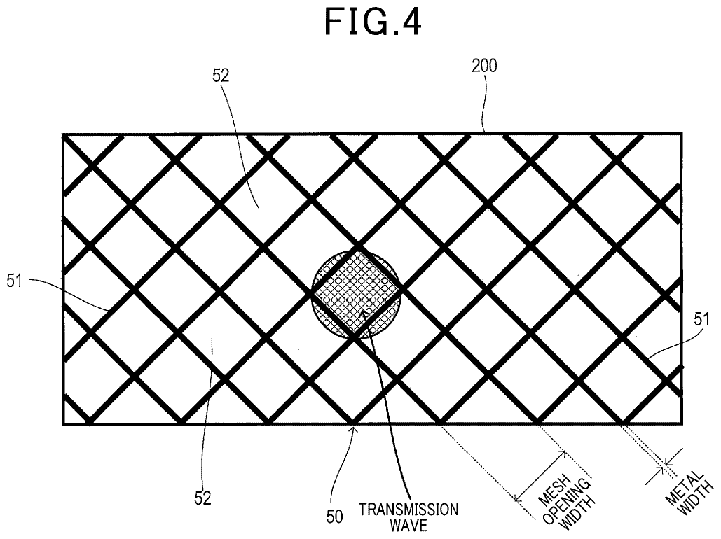

As illustrated in FIG. 4, the ranging device 1 includes a metal mesh heater 50.

The metal mesh heater 50 is formed by braiding a plurality of metal wires 51 of silver, copper or the like into a mesh, and is disposed so as to cover the back surface of the optical window 200 (that is, the inner surface of the optical window 200). The metal mesh heater 50 may also be disposed to cover the surface of the optical window 200.

The metal mesh heater 50 heats the optical window 200 by energizing the plurality of metal wires 51 to generate heat in the plurality of metal wires 51.

The metal mesh heater 50 has a plurality of rectangular mesh openings 52 delimited by the plurality of metal wires 51 by forming a mesh of metal wires 51.

The metal mesh heater 50 may be formed directly on the optical window 200 by printing, photolithography and etching. The metal mesh heater 50 may be formed in film form and bonded onto the optical window 200. The metal mesh heater 50 may be embedded within the optical window 200 by insert molding.

The width of each mesh opening 52 is set to be greater than the wavelength of the transmission wave that passes through the optical window 200, and less than wavelengths of electromagnetic waves that are noise in the ranging device 1 (in the present embodiment, for example, 3 mm). In the present embodiment, the opening width of each mesh opening 52 is 1 mm.

In addition, the metal mesh heater 50 is formed such that the ratio of the area of the metal wires 51 that block the transmission wave to the area of the optical window 200 that the transmission wave that passes is 10% or less.

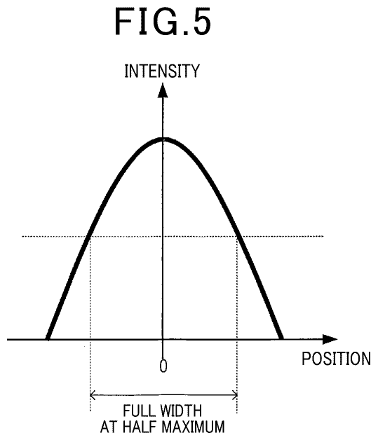

As illustrated in FIG. 5, the intensity distribution of laser light is usually a Gaussian distribution. In the present embodiment, the area of the optical window 200 that the transmission wave that passes is the area of a circle with a diameter equal to the full width at half maximum in the intensity distribution of the transmission wave.

The ranging device 1 configured as above includes the transmitting section 11, the receiving section 12, the housing 100, the optical window 200, and the metal mesh heater 50.

The transmitting section 11 transmits transmission waves. The receiving section 12 receives reflection waves caused by reflection of the transmission waves from an object.

The housing 100 houses the transmitting section 11 and receiving section 12 inside, and has the opening 100a formed to allow transmission waves and reflected waves to pass therethrough.

The optical window 200 is made of a material transparent to the transmission and reflection waves and covers the opening 100a.

The metal mesh heater 50 has a plurality of mesh openings 52 formed in a mesh using metal. The metal mesh heater 50 is disposed so as to cover at least a portion of the opening 100a and heats the optical window 200 by generating heat when energized.

In such a ranging device 1, the metal mesh heater 50 is disposed so as to cover at least a portion of the opening 100a. Therefore, the ranging device 1 can improve the capability of heating the optical window 200 using the metal mesh heater 50. This can prevent occurrence of a situation where transmission waves and reflection waves fail to pass through the optical window 200 due to insufficient removal of snow and water droplets adhering to the ranging device 1.

Furthermore, in the ranging device 1, the metal mesh heater 50 has a plurality of mesh openings 52, which are formed in a mesh using metal. Therefore, even in a configuration where the metal mesh heater 50 is disposed so as to cover a portion of the opening 100a, this can prevent the transmission and reflection waves from being blocked by the metal mesh heater 50.

From the above, the ranging device 1 can improve its ranging performance.

Furthermore, in the ranging device 1, the metal mesh heater 50 is disposed so as to cover at least a portion of the opening 100a, and the metal mesh heater 50 is formed in a mesh using metal. This allows the ranging device 1 to prevent noise-causing electromagnetic waves from passing through the optical window 200 and entering the housing 100.

In the embodiment described above, the optical window 200 corresponds to the transmissive section, and the metal mesh heater 50 corresponds to the heating section.

### Second Embodiment

A second embodiment of the present disclosure will now be described with reference to accompanying drawings. Only differences of the second embodiment from the first embodiment will be described. The same constituents are assigned the same numbers.

The ranging device 1 of the second embodiment differs from that of the first embodiment in that the configuration of the metal mesh heater 50 is modified.

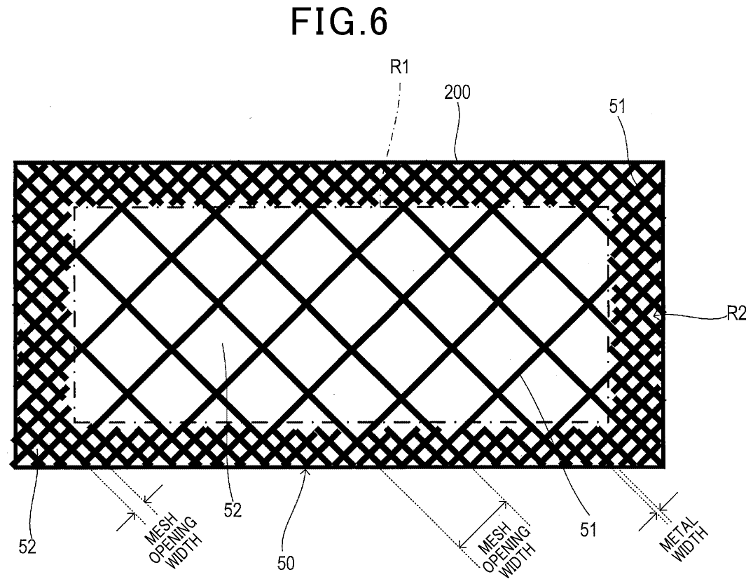

As illustrated in FIG. 6, the metal mesh heater 50 of the second embodiment is formed such that the metal mesh in a light non-transmissive region R2 of the optical window 200, through which the transmission waves can not pass is finer than the metal mesh in a light transmissive region R1 of the optical window 200, through which the transmission waves can pass.

The light transmissive region R1 is formed in a rectangular shape in the centre of the surface of the optical window 200. The light non-transmissive region R2 is a region other than the light transmissive region R1 on the surface of the optical window 200 and is formed to cover the periphery of the light transmissive region R1.

Specifically, the opening width of each mesh opening 52 in the light transmissive region R1 (hereinafter referred to as a mesh opening width) is greater than the mesh opening width in the light non-transmissive region. The mesh opening width in part of the light non-transmissive region R2 may be less than the mesh opening width in the light transmissive region R1.

In the ranging device 1 configured as above, the metal mesh heater 50 is formed such that the mesh opening width changes depending on the position where the opening 100a is covered.

Specifically, the metal mesh heater 50 is formed such that a passage opening width setting condition is met. The passage opening width setting condition is that the mesh opening width in the light transmissive region R1, which is a region through which the transmission and reflection waves pass through in the opening 100a, is greater than the mesh opening width in at least a portion of a region other than the light transmissive region R1 in the opening 100a (in the present embodiment, the light non-transmissive region R2).

The metal mesh heater 50 has a finer mesh in the light non-transmissive region R2 than in the light transmissive region R1, which can further improve the capability of heating the optical window 200 using the metal mesh heater 50. This can further improve the capability of shielding noise using the metal mesh heater 50.

In the above-described embodiment, the light transmissive region R1 corresponds to a wave pass region.

### Third Embodiment

A third embodiment of the present disclosure will now be described with reference to accompanying drawings. Only differences of the third embodiment from the second embodiment will be described. The same constituents are assigned the same numbers.

The ranging device 1 of the third embodiment differs from that of the second embodiment in that the configuration of the metal mesh heater 50 is modified.

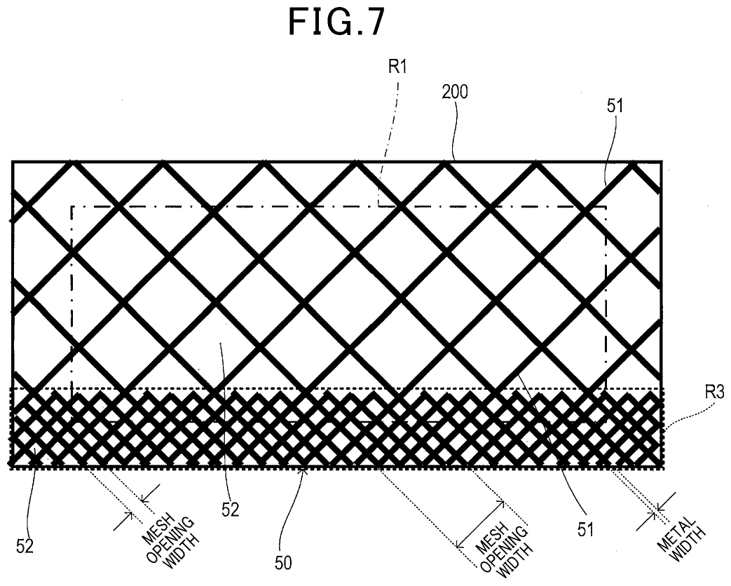

As illustrated in FIG. 7, the metal mesh heater 50 of the third embodiment is formed such that the metal mesh in a lower region R3 of the optical window 200 is finer than the metal mesh in the region other than the lower region R3 of the optical window 200. The lower region R3 is a lower region on the surface of the optical window 200. The lower region R3 may partially overlap the light transmissive region R1.

Specifically, the opening width of each mesh opening 52 in the lower region R3 is less than the opening width of each mesh opening 52 in the region other than the lower region R3.

In the ranging device 1 configured as above, the metal mesh heater 50 is formed such that a lower opening width setting condition is met. The lower opening width setting condition is that the mesh opening width in the lower region R3 corresponding to a lower region of the opening 100a is less than the mesh opening width in an upper region of the opening 100a than the lower region R3.

When the ranging device 1 mounted to the vehicle transmits transmission waves forward, most of the transmission waves transmitted downward from the travel direction of the vehicle may be reflected from the road surface. Thus, a required detection distance is reduced for transmission waves transmitted downward (that is, transmission waves that pass through the lower region R3).

Therefore, even if the optical performance of the ranging device 1 is reduced by providing such a finer metal mesh in the lower region R3, the effect on the distance detection performance is small.

The ranging device 1 can improve the temperature increase performance in the lower region R3 of the optical window 200. Since the optical window 200 is arranged almost perpendicularly to the road surface, melting of the snow adhering to the surface of the optical window 200 causes all the snow adhering to the surface of the optical window 200 to fall off more easily.

Therefore, the ranging device 1 of the third embodiment can further improve its capability of removing snow adhering to the ranging device 1.

In the embodiment described above, the lower region R3 corresponds to an opening's lower region, and the region of the optical window 200 other than the lower region R3 corresponds to an opening's upper region.

### Fourth Embodiment

A fourth embodiment of the present disclosure will now be described with reference to accompanying drawings. Only differences of the fourth embodiment from the second embodiment will be described. The same constituents are assigned the same numbers.

The ranging device 1 of the fourth embodiment differs from that of the second embodiment in that the configuration of the metal mesh heater 50 is modified.

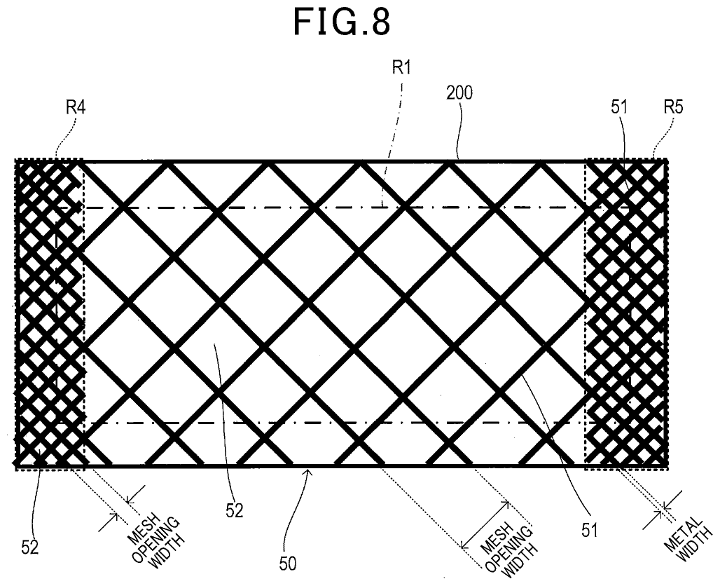

As illustrated in FIG. 8, the metal mesh heater 50 of the third embodiment is formed such that the metal mesh in a left region R4 and a right region R5 of the optical window 200 is finer than the metal mesh in the region other than the left region R4 and the right region R5 of the optical window 200. The left region R4 is a left region on the surface of the optical window 200. The right region R5 is a right region on the surface of the optical window 200. The left region R4 and the right region R5 may partially overlap the light transmissive region R1.

Specifically, the opening width of each mesh opening 52 in each of the left region R4 and the right region R5 is less than the opening width of each mesh opening 52 in the region other than the left region R4 and the right region R5.

In the ranging device 1 configured as above, the metal mesh heater 50 is formed such that a left and right opening width setting condition is met. The left and right opening width setting condition is that the mesh opening width in each of the left region R4 and the right region R5 corresponding to left and right regions of the opening 100a is less than the mesh opening width in the region of the opening 100a other than the left region R4 and the right region R5.

When the ranging device 1 mounted to the vehicle transmits transmission waves forward, the transmission waves transmitted leftward or rightward from the travel direction of the vehicle may be reflected from walls or other vehicles to the left or right of the vehicle. Thus, a required detection distance is reduced for transmission waves transmitted leftward or rightward (that is, transmission waves that pass through the left region R4 or the right region R5).

Therefore, even if the optical performance of the ranging device 1 is reduced by providing such a finer metal mesh in each of the left region R4 and the right region R5, the effect on the distance detection performance is small.

The ranging device 1 can improve the temperature increase performance in each of the left region R4 and the right region R5 of the optical window 200. Since the optical window 200 is arranged almost perpendicularly to the road surface, melting of the snow adhering to the left region R4 and the right region R5 causes all the snow adhering to the surface of the optical window 200 to fall off more easily.

Therefore, the ranging device 1 of the fourth embodiment can further improve its capability of removing snow adhering to the ranging device 1.

In the embodiment described above, the left region R4 and right region R5 correspond to opening's left and right regions, and the region of the optical window 200 other than the left region R4 and right region R5 corresponds to an opening's central region.

### Fifth Embodiment

A fifth embodiment of the present disclosure will now be described with reference to accompanying drawings. Only differences of the fifth embodiment from the first embodiment will be described. The same constituents are assigned the same numbers.

The ranging device 1 of the fifth embodiment differs from that of the first embodiment in that the configuration of the metal mesh heater 50 is modified.

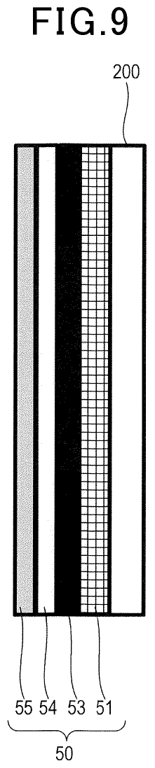

As illustrated in FIG. 9, the metal mesh heater 50 of the fifth embodiment differs from the first embodiment in that the metal mesh heater 50 includes a blackened layer 53, an overcoat layer 54 and an AR coating layer 55.

The metal mesh heater 50 has a structure in which the plurality of metal wires 51, the blackened layer 53, the overcoat layer 54 and the AR coat layer 55 are sequentially stacked on the back surface of the optical window 200, in order of proximity to the optical window 200.

The blackened layer 53 is formed by applying a surface treatment to the plurality of metal wires 51, which has the effect of reducing the reflectivity for the transmission wave wavelength.

The overcoat layer 54 is a film or resin formed on the blackened layer 53 to protect the plurality of metal wires 51.

The AR coating layer 55 is a film or resin or metal that has the effect of reducing the reflectivity for the transmission wave wavelength.

In the ranging device 1 configured as above, the metal mesh heater 50 includes the blackened layer 53, the overcoat layer 54 and the AR coating layer 55 on the metal wires 51 that delimit the plurality of mesh openings 52 adjacent to each other. The blackened layer 53 is a layer with a reflectivity reduction treatment applied thereto to reduce reflections of transmission and reflection waves on the metal wires 51. The overcoat layer 54 is a layer for protecting the surfaces of the metal wires 51. The AR coating layer 55 is a layer for reducing reflections of transmission and reflection waves.

The ranging device 1 configured as above can suppress reflections of transmission and reflection waves and damages to the metal mesh heater 50.

In the embodiments described above, the blackened layer 53 corresponds to a reflectivity reducing layer, the overcoat layer 54 corresponds to a protection layer and the AR coat layer 55 corresponds to a reflection suppressing layer.

### Sixth Embodiment

A sixth embodiment of the present disclosure will now be described with reference to accompanying drawings. Only differences of the sixth embodiment from the first embodiment will be described. The same constituents are assigned the same numbers.

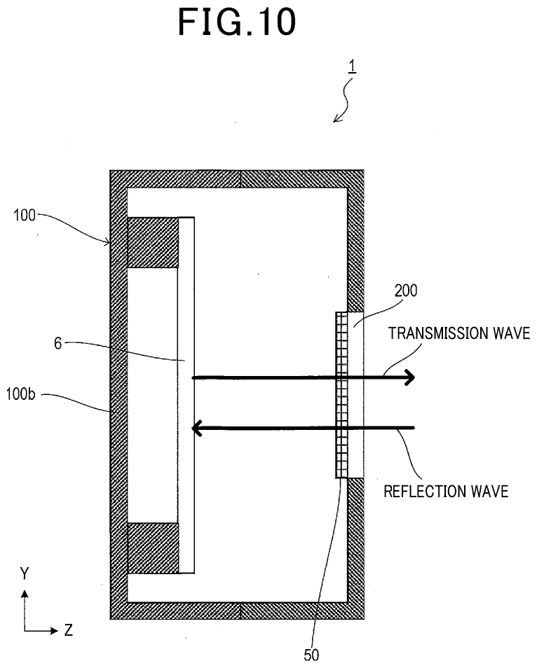

The ranging device 1 of the sixth embodiment differs from that of the first embodiment in that the detection module 2 and control board 3 are omitted, and a detection board 6 is added, as illustrated in FIG. 10.

The detection board 6 is housed within the housing 100. The detection board 6 employs an electronic scanning scheme and is equipped with, although not shown, a control section, a transmission array antenna and a reception array antenna.

The transmission array antenna includes a plurality of transmission antenna elements arranged at regular intervals on the detection board 6. The control section changes the transmit direction of the transmission wave transmitted from the transmission array antenna by changing the phase or other parameters of a transmission signal supplied to each of the plurality of transmission antenna elements.

The reception array antenna includes a plurality of reception antenna elements arranged at regular intervals on the detection board 6. When the transmission wave transmitted from the transmission array antenna is reflected by an object, each reception antenna element of the reception array antenna receives the reflection wave and outputs the received reflection wave as a reception signal.

The control section determines the direction in which the reflection wave has entered the reception array antenna based on the phase of the reception signal output by each reception antenna element.

The detection board 6, inside the housing 100, is positioned at the rear of the housing 100 (that is, at the back side of the housing 100), with the transmission array antenna and reception array antenna facing the optical window 200.

Specifically, the detection board 6 is disposed inside the housing 100 such that the portion 100b of the outer wall of the housing 100 that faces the optical window 200 is closer to the detection board 6 than to the optical window 200.

### Seventh Embodiment

A seventh embodiment of the present disclosure will now be described with reference to accompanying drawings. Only differences of the seventh embodiment from the sixth embodiment will be described. The same constituents are assigned the same numbers.

The ranging device 1 of the seventh embodiment differs from that of the sixth embodiment in that the arrangement of the detection board 6 is modified.

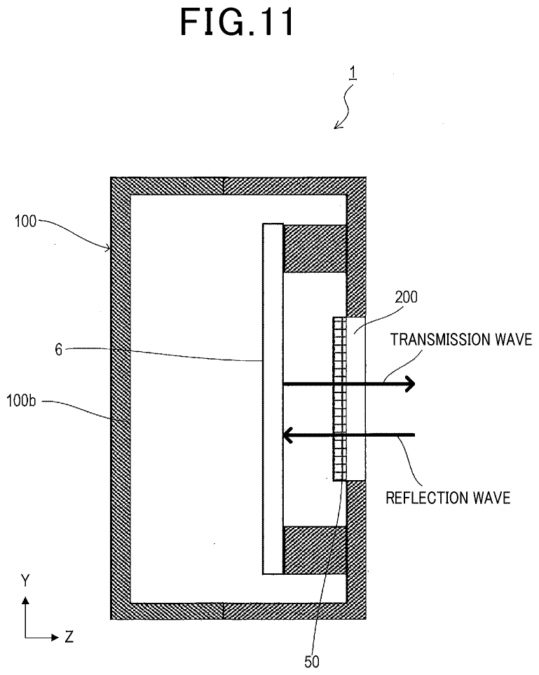

As illustrated in FIG. 11, the detection board 6 is disposed within the housing 100 at the front side (that is, at the opening side of the housing 100), with the transmission array antenna and the reception array antenna facing the optical window 200.

Specifically, the detection board 6, inside the housing 100, is disposed such that the detection board 6 is closer to the optical window 200 than to the portion 100b of the outer wall of the housing 100 that faces the optical window 200.

In the ranging device 1 configured as above, the detection board 6 is disposed near the optical window 200. This facilitates transfer of heat generated in the detection board 6 to the optical window 200 side of the housing 100, and liberation of the transferred heat via exposure to the air flow caused by traveling of the vehicle. In addition, although the optical window 200 is made of resin or glass that resists transfer of heat, providing the metal mesh heater 50 can facilitate heat transfer. Therefore, the area exposed to the air flow caused by traveling of the vehicle is increased, which facilitates dissipation of the heat generated in the detection board 6. The ranging device 1 of the seventh embodiment can therefore improve the heat dissipation efficiency of the detection board 6.

It is to be understood that the disclosure is not to be limited to the specific embodiment disclosed above and that modifications and other embodiments are intended to be included within the scope of this disclosure.

### First Modification

For example, in each of the above second, third and fourth embodiments, the metal mesh heater 50 is formed such that the mesh opening width changes according to the position where the opening 100a is covered. However, the metal mesh heater 50 may be formed such that the wire width (hereinafter referred to as the metal width) of each metal wire 51 may change according to the position where the opening 100a is covered.

Specifically, the metal mesh heater 50 may be formed such that a passage metal width setting condition is met. The passage metal width setting condition is that the metal width in the light transmissive region R1 of the opening 100a, which is the region through which the transmission and reflection waves pass, is less than the metal width in at least a portion of the region of the opening 100a other than the light transmissive region R1 (that is, the light non-transmissive region R2).

In an alternative, the metal mesh heater 50 may be formed such that a lower metal width setting condition is met. The lower metal width setting condition is that the metal width in the lower region R3, which corresponds to the lower region of the opening 100a, is greater than the metal width in the region above the lower region R3 of the opening 100a.

In a still alternative, the metal mesh heater 50 may be formed such that a left and right metal width setting condition is met. The left and right metal width setting condition is that the metal width in the right region R5 and left region R4, which correspond to the right and left regions of the opening 100a, is greater than the metal width in the region other than the right region R5 and left region R4 of the opening 100a.

### Second Modification

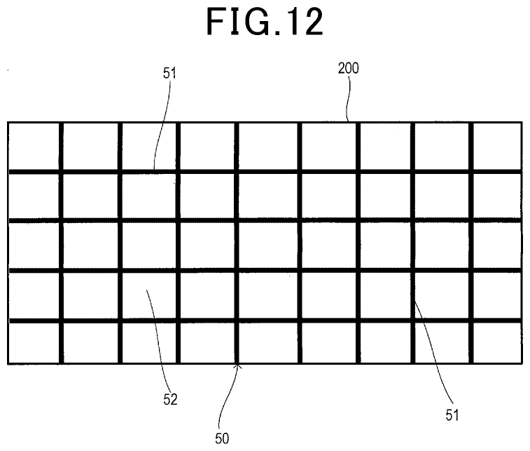

In each of the above embodiments, the plurality of mesh openings 52 are formed by diagonally arranging the plurality of metal wires 51. However, the arrangement of the plurality of metal wires 51 may be any arrangement that can form a plurality of mesh openings 52. For example, as illustrated in FIG. 12, the plurality of metal wires 51 may be arranged along the horizontal and vertical directions.

The functions of a single component may be distributed over a plurality of components, or a single function of a single component may be implemented by a plurality of components. A plurality of functions of a plurality of components may be implemented by a single component. A single function implemented by a plurality of components may be implemented by a single component. At least part of the configuration of the above embodiments may be removed. At least part of the configuration of one of the above embodiments may be replaced with or added to the configuration of another one of the above embodiments.

What is claimed is:

1. A ranging device comprising:
a transmitting section configured to transmit a transmission wave;
a receiving section configured to receive a reflection wave caused by reflection of the transmission wave from an object;
a housing enclosing the transmitting section and the receiving section and has an opening formed for allowing the transmission wave and the reflection wave to pass therethrough;
a transmissive section formed of a material transparent to the transmission wave and the reflection wave, and covering the opening;
a mesh of metal having a plurality of mesh openings; and
a heating section disposed to cover at least a portion of the opening and configured to generate heat by energising the metal to heat the transmissive section.

2. The ranging device according to claim 1,
a width of each of the plurality of mesh openings is referred to as a mesh opening width, and
the mesh opening width of each of the plurality of mesh openings is greater than a wavelength of the transmission wave and less than a wavelength of an electromagnetic wave as noise in the ranging device.

3. The ranging device according to claim 1,
the heating section is formed such that a ratio of an area of the metal blocking the transmission wave to an area of the transmissive section that the transmission wave passes is 10% or less.

4. The ranging device according to claim 1,
a width of each of the plurality of mesh openings is referred to as a mesh opening width,
a width of the metal delimiting the plurality of the mesh openings adjacent to each other is referred to as a metal width, and
the heating section is formed such that at least one of the mesh opening width and the metal width changes depending on a position where the opening is covered.

5. The ranging device according to claim 4, wherein
the ranging device is mounted to a vehicle, and
the heating section is formed such that at least one of a lower opening width setting condition and a lower metal width setting condition is met,
the lower opening width setting condition is that the mesh opening width in an opening's lower region which is a lower region of the opening is less than the mesh opening width in an opening's upper region which is a region of the opening upper than the opening's lower region, and
the lower metal width setting condition is that the metal width in the opening's lower region is greater than the metal width in the opening's upper region.

6. The ranging device according to claim 4, wherein
the ranging device is mounted to a vehicle, and
the heating section is formed such that at least one of a left and right opening width setting condition and a left and right metal width setting condition is met,
the left and right opening width setting condition is that the mesh opening width in each of opening's left and right regions which are left and right regions of the opening is less than the mesh opening width in an opening's central region which is a region of the opening other than the opening's left and right regions, and
the left and right metal width setting condition is that the metal width in each of the opening's left and right regions is greater than the metal width in the opening's central region.

7. The ranging device according to claim 4, wherein
the heating section is formed such that at least one of a passage opening width setting condition and a passage metal width setting condition is met,
the passage opening width setting condition is that the mesh opening width in a wave transmissive region which is a region of the opening through which the transmission and reflection waves pass is greater than the mesh opening width in at least a portion of a region other than the wave transmissive region, and
the passage metal width setting condition is that the metal width in the wave transmissive region of the opening is less than the metal width in at least a portion of the region of the opening other than the wave transmissive region.

8. The ranging device according to claim 1,
the heating section comprises, on the metal that delimits the plurality of mesh openings adjacent to each other, at least one of:
a reflectivity reducing layer with a reflectivity reduction treatment applied thereto to reduce reflections of the transmission and reflection waves on the metal;
a protection layer for protecting a surface of the metal; and
a reflection suppressing layer for reducing reflections of the transmission and reflection waves.

9. The ranging device according to claim 1, further comprising
a detection board provided with the transmitting section and the receiving section, wherein the detection board is disposed inside the housing such that the detection board is closer to the transmissive section than to a portion of an outer wall of the housing that faces the transmissive section.
